(19) United States
(12) Patent Application Publication
(10) Pub. No.: US 2021/0017615 A1
(43) Pub. Date: Jan. 21, 2021

(54) Layered Material And Method For Producing A Layered Material

(71) Applicant: Philipp Schaefer, Hannover (DE)

(72) Inventor: Philipp Schaefer, Hannover (DE)

(21) Appl. No.: 16/980,444

(22) PCT Filed: Mar. 22, 2018
(86) PCT No.: PCT/EP2018/057230

§ 371 Date: Sep. 14, 2020

(30) Foreign Application Priority Data
Mar. 13, 2018 (WO) PCTEP2018056212

(51) Int. Cl. C14C 11/00; C08G 18/08; C08G 18/44; C08G 18/48; C08J 9/30; D06N 3/00; D06N 3/14; D06N 3/18

(52) U.S. Cl. CPC C14C 11/006; C08G 18/0866; C08G 18/44; C08G 18/48; C08G 2101/0008; D06N 3/0047; D06N 3/141; D06N 3/0077; D06N 3/183; C08J 9/30

(57) ABSTRACT

A method for producing a layered material, which has a substrate layer and a layer of polyurethane bonded to the substrate layer. A leather, preferably a sanded grain leather, a textile material, preferably a woven fabric or a knitted fabric, a bonded leather material, or a microfiber nonwoven is used as the substrate layer and is bonded to the layer. According to the present teaching, at least one, preferably a single, layer of frothed polyurethane foam is applied to the substrate as the layer.

### TECHNICAL FIELD

The present teaching relates to a method for producing a layered material. In addition the present teaching relates to the method or a use of an object that can be obtained by using an inventive layered material.

### BACKGROUND

Capillaries penetrating through a polyurethane layering are described in U.S. patent US 61/770,198 and patent EP 1644530. These capillaries extend through all layers of the material and have different diameters and form different depressions on the surface. As a result, water enters the larger capillaries from the outside and the surface becomes unsightly, especially with smooth grains. Known materials or coatings, which have been produced on reverse matrices, consist of several layers. Delamination separations are therefore preprogrammed. By using a layered structure, however, a so-called plywood effect is produced; that is, the support materials are automatically stiffer after coating. Known layered materials are relatively hard. According to the present teaching, soft layer materials can be produced which, without capillaries and with a homogeneous surface appearance, have a water vapor permeability of at least 0.6 mg/cm²/h or even more, or at least 1.2 mg/cm^{2/}h in accordance with DIN EN ISO 14268, and which, with hot embossing—due to their inventive foam structure —prevent the maintenance of the full temperature of the matrix while it is pressed onto the substrate layer. Higher temperatures are perceived as a stress in both a microfiber nonwoven and leather, and the substrate materials harden and lose strength, especially when moisture, heat, and pressure together act on the substrate layer.

A disadvantage of known materials provided with perforations or capillaries is also that coatings, for example in shoes, absorb moisture and convey it to the wearer.

### SUMMARY

One object of the present teaching is to create a layered material which is easy to produce and storable, allows precise surface structuring, has the best mechanical or physical properties and is economically producible and capable of refinement. The layer is to be constructed as a single layer from aqueous PU dispersions and, even at a thickness of more than 0.4 mm, should have no gaps, sink marks, bubbles or drying-induced cracks. In addition, the wet coating should not substantially lose any thickness during drying or water use.

According to the present teaching, a method of the aforementioned type is characterized by the features cited herein.

With this procedure, a layered material is obtained in which a substrate layer bears a surface-structurable layer, whose layer material can be further refined even after prolonged storage. For this purpose, it is only necessary to thermally activate the surface-structurable layer and to shape it above its softening point thermoplastically with a matrix or an embossing roll under heat and pressurization. The layer retains its structure after the matrix is removed.

It is advantageous if the layer is dried after application to the substrate layer to a water content of less than 1.5 wt. %, preferably less than 0.5 wt. %, in particular until removal of all water content, and/or if an aqueous polyurethane dispersion or an aqueous polyurethane compound based on aliphatic polyether and/or polyester and/or polycarbonate polyurethane is used to produce the polyurethane foam, and/or if the polyurethane foam is produced with a polyurethane dispersion compound where the individual polyurethane dispersions used to prepare the PU dispersion mixture display different softening points in dried condition, and/or if the polyurethane dispersions are selected in such a way that the polyurethane dispersion or polyurethane dispersion compound possesses thermoplastic properties before it is cross-linked, and/or if the final mixture used to produce the polyurethane foam contains 65 to 91 wt. % polyurethane dispersions, such that the polyurethane dispersion or dispersions used to produce the polyurethane foam contain in each case 35 to 52 wt. % solids, and/or the polyurethane of the polyurethane dispersions used has at least partially linear and/or has at least partially crystalline and/or thermoplastic or amorphous structure.

A foamable PU dispersion thus contains between 65 and 91 wt. % polyurethane dispersion or polyurethane dispersions based on the total weight of the polyurethane foam. The rest are additives such as polyacrylate dispersions, thickeners, pigments, flame retardant additives, foaming agents and cross-linkers. Use is made of polyurethane dispersions which in each case contain between 35 and 52 wt. % solids, based on the total weight of the respective polyurethane dispersion.

The softening point of the foam can be determined not only by selecting the softening point of the individual polyurethane dispersions, but can also be controlled by adding cross-linkers. Usually, 1.5 to 7 wt. %, advantageously 3 to 5 wt. %, of the cross-linker, based on the total weight of the polyurethane foam, is used. One cross-linker of this kind is, for example, XL80 from the Lanxess company.

Advantageously, polyurethane dispersions are used which, when still not cross-linked or still in the dried state, have a softening point above 45° C., and thus become soft and sticky above this temperature. The softening point may also be above 95° C. when cross-linkers are used. Before cross-linking, the dried polyurethane dispersions or polyurethane dispersion compounds have thermoplastic properties and are viscous under pressure at these temperatures and can be permanently reshaped. For embossing, the foam layer should be honey-like, viscous but not thin-bodied in order to be able to assume the structure of the matrix accurately and quickly. The softening point can be set or selected according to the application of the layered material.

Advantageously, thickeners are used on anhydrous polyacrylate base of viscous consistency or ammonia-containing auxiliary foam pastes, e.g. Melio Foam. Polyacrylate-based thickeners which stabilize the polyurethane foam are used in a 1 to 5wt. % quantity based on the total weight of the polyurethane foam.

Polyurethane dispersions based on aliphatic polyether and/or polyester and/or polycarbonate polyurethanes are used for producing the polyurethane foam. The polyurethane dispersions used for the preparation of polyurethane dispersion compounds may have different softening points or be selected or mixed together to achieve this effect. It is thus possible to select different softening points or softening areas for the dried polyurethane foam. By heating to this softening point or above it, or on a softening area allowing the embossing, it is possible to impart a desired surface structure to the anhydrous polyurethane foam, which is thermoplastic or thermoplastically surface-structurable before it is cross-linked.

The polyurethane dispersions used to produce polyurethane foam advantageously contain in each case 35 to 52 wt. % solid polyurethane, based on the respective weight of the polyurethane dispersion used. The individual polyurethane dispersions are then combined or mixed to form the polyurethane dispersion mixture and the polyurethane dispersion mixture used to prepare the polyurethane foam contains from 65 to 91 wt. % of such polyurethane dispersions, based on the total weight of the polyurethane foam.

According to the present teaching, particularly good properties with regard to adhesion of the coating 2 to the substrate 1 are achieved when a dispersion compound is used which contains between 18 and 52 wt. % based on the finished dispersion compound of a commercial polyester-based polyurethane dispersion containing solid content of about 40%, as offered for example as heat-activatable industrial contact adhesive under the name Luphen from BASF. The remaining 39 to 73 wt. % is provided by a polyurethane dispersion with a softening point above +125° C., and likewise containing about 40% solids, such as a dispersion called DLV-N from Lanxess. This mixture results in exceptionally high adhesion properties, especially in microfiber nonwovens and sanded grain leathers, without appreciably hardening the final product.

The polyurethane in polyurethane dispersions has at least partially linear and/or at least partially crystalline and/or amorphous structure and is thermoplastically shapable in the dried state and can also be thickened as a foam.

Polyurethane dispersion compounds are mainly used to adjust or optimize the hydrolysis resistance, temperature resistance and solubility behavior of the foam.

The chosen polyurethane dispersion or the polyurethane dispersions for the polyurethane dispersion compound to produce the polyurethane foam have a pH of 6 to 8.5.

It is advantageous for storage when the dried polyurethane foam is anhydrous and not cross-linked and softens at a temperature between 110 and 160° C. or becomes highly viscous and melts and flows under pressure in order to be able to assume the structure of the matrix.

The polyurethane foam is created by if a gas, preferably air or nitrogen, is introduced into a polyurethane dispersion or a polyurethane dispersion compound, so that sufficient gas is introduced or whipped into one liter of the polyurethane dispersion compound to bring one liter of the starting material to a volume of 1.20 to 1.70 l, preferably 1.30 to 1.50 l.

The inventive procedure is simple and cost-effective. It is possible for the polyurethane foam to be sprayed onto the substrate layer, in particular airlessly, or applied by silk screening or with at least one roller or Rakel blade of the same thickness. This facilitates adjustment of the applied layer of polyurethane foam to the desired thickness.

For special application purposes, it may be advantageous if, before or simultaneously with the structuring of the polyurethane foam by the matrix, a further layer of a polyurethane dispersion optionally having a different color is applied or bonded and cross-linked or fastened to the layer directly or by previous application to the matrix. This layer has a thickness of 0.015 to 0.060 mm, preferably 0.020 to 0.045 mm. In this way, in addition to a protective effect, a different coloring can be obtained for the surface of the layered material. If portions of the applied further layer are removed, for instance by lasers, and the applied further layer has a different color from the polyurethane foam, different-colored shaped patterns can be formed on the layer material. The layer can be applied directly onto the polyurethane foam, which is already situated on the substrate layer and advantageously already dried. However, it is also possible to apply this additional layer to the matrix before embossing the polyurethane foam with the matrix, and after embossing the polyurethane foam with the matrix, to connect the further layer directly from the matrix with the surface of the polyurethane foam or to transfer it to the said surface.

The substrate layer provided with the layer of dried polyurethane foam or the layer material can be produced in sheet material or in the form of blanks and can be stored after the polyurethane foam has dried.

According to the present teaching, to produce a surface-structured layer material, the dried layer, either simultaneously or together with the additional layer as the case may be, is pressured with a structured matrix or embossing roll and if necessary reduced in thickness, specifically at a temperature between 110 and 160° C., where, for a heated matrix, a contact time between 2 and 18 seconds and a contact pressure of 0.02 to 1.8 kg/cm2,are maintained, and for a cold embossing roller a contact time of 0.5 to 15 seconds, preferably 3 to 15 seconds, and a contact pressure from 0.02 to 1.8 kg/cm2 are maintained, or the layer 2 of polyurethane foam, either simultaneously or together with the other layer, is brought to a temperature of 110 to 160° C., for example with IR radiation, and is pressured with an embossing roll that is cold or heated to 75° C. maximum and structured and, if necessary, reduced in thickness.

It can be provided that the polyurethane foam contains additives, e.g. gas-filled hollow microspheres and/or pigments and/or polyacrylate dispersions and/or silicones and/or matting means and/or thickeners and/or flame retardants. In this case, based on the total weight of the polyurethane foam, 1.5 to 3.5 wt. % of hollow microspheres or 2 to 12 wt. % of pigments or 1.8 to 4.5 wt. % of polyacrylates are added as thickener or foam stabilizer or 1 to 4 wt. % of silicones are added.

It is also possible according to the present teaching that the polyurethane foam is created so that the layer 2 after structuring with the matrix 4 has a density of 0.780 to 1.03 g/cm3. The density depends largely on the type and amount of pigments. A foam dyed white with titanium dioxide naturally has a higher density than a black foam. Furthermore, it is possible for cross-linkers in the amount of 0.9 to 4.2 wt. % and/or 8 to 25 wt. % each of a 40 to 60% acrylate dispersion to be added to the polyurethane foam. The weights are based on the total weight of the polyurethane foam.

The additional layer applied to the surface of the dried polyurethane foam may have the same or a similar composition as the polyurethane dispersion mixture or mixtures used for the polyurethane foam. Above all, however, the color pigments used can have a different color.

For the production of a layered material in which a textile material, such as a woven or knitted fabric, is used as a substrate layer, it has proved to be particularly advantageous if, before applying the layer of polyurethane foam to a substrate layer made of a textile, such as woven or knitted fabric, there is a thin layer on the surface of the textile material, said layer consisting of polyurethane foam or alternatively of foamed soft PVC, each having a thickness of 0.25 to 0.40 mm, or a cross-linked polyurethane dispersion foam layer of the same strength. The substrate layer is thus coated with a layer of foamed soft PVC or a cross-linked polyurethane foam.

An inventive layered material is characterized by the features of the present teachings. Such a layered material can be surface-structured even after prolonged storage at elevated temperature and simultaneous application of pressure.

According to the present teaching, the polyurethane foam of the layered material has a specific weight of 0.8 to 1.03 kg/dm3, and/or the layer of polyurethane foam has a thickness of 0.030 to 0.40 mm, preferably 0.070 to 0.350 mm, and/or the polyurethanes used for the layer are aliphatic polyurethanes based on polyethers or polyesters or polycarbonates, and/or the layer of polyurethane foam contains pigments and/or cross-linkers and/or polyacrylates and/or hollow microspheres, and/or the layer of solidified, dried polyurethane foam has a shore A hardness of 28 to 68, and/or structuring is formed or embossed on the surface of the layer, and/or the structured and cross-linked layer is thermoplastic, and/or the polyurethane foam layer has a thickness which is only 2 to 18%, preferably 3 to 9%, thicker than a layer consisting of an equally weighing amount of non-foamed polyurethane dispersion or non-foamed polyurethane dispersion compound of the same composition after this amount has been distributed over an area of the same size as the polyurethane foam.

The increase in density due to the reduction of the thickness occurs uniformly over the thickness of the layer 2.

Measurement of the shore A hardness is carried out in such a way that a number of the layers to be examined are made of the particular material, preferably solidified or dried or compacted polyurethane foam, and are stacked so that a test model with a thickness of 5 mm is formed based on the standard DIN ISO 7619-1, and is then measured.

The usability and processability of the layer material is optimized, or surface protection of the structured polyurethane foam is achieved, if a thin extra layer of foamed soft PVC or of a cross-linked polyurethane or a cross-linked polyurethane dispersion compound, preferably of aliphatic polyurethane on a polyester or polyether or polycarbonate base, is configured in a substrate layer made of a textile material between the surface of the textile material and the layer, and the said extra layer has a thickness of 0.25 to 0.40 mm and forms a bonding layer for the layer of polyurethane foam that is to be applied, so that the two layers can, depending on the case, form a total thickness of 0.35 to 0.80 mm. Advantageously, the present teaching can provide that the surface of the layer 2 includes a thin heat-structurable, non-foamed layer of a dried polyurethane dispersion having a thickness of 0.0150 to 0.50 mm, preferably 0.020 to 0.0350 mm, applied or bonded to the layer, so that in the layer of polyurethane foam a structure corresponding to the structural embossing in the layer is configured or embossed and so that the layer advantageously has a greater shore A hardness than the layer of polyurethane foam, or a shore A hardness of more than 70 and, depending on the case, 1 to 4 wt. % of polysiloxanes.

If a leather is used as the substrate layer, it has proved advantageous for the grain leather to be a steer's grain leather, preferably top-grain steer's leather, calfskin, goat leather or kangaroo leather, or a leather in which the grain layer has advantageously been removed mechanically by at least 5% to a maximum of 60%.

If a microfiber nonwoven serves as the substrate layer, it is advantageous if the fibers of the microfiber nonwoven consist of polyester or polyamide, while the spaces between the fibers are impregnated or filled with a synthetic, preferably based on polyurethane, having a foam structure or a coagulated microcellular structure, and/or the polyurethane foam has an open cellular structure and/or is permeable to air and/or has a water vapor permeability of more than 0.050 mg/cm2/h, preferably of more than 0.12 mg/cm2/h, according to DIN EN ISO 14268.

It is advantageous if the polyurethane foam is of open cellular configuration, permeable to air and to water vapor.

According to the present teaching, the layer material is particularly advantageous for the production of articles such as sheet goods, blanks, stamping parts, shoe parts, sports and work shoes, shoe insoles, bags, leather goods, steering wheel covers, upholstery covers, interior wall coverings and seat covers for motor vehicles and partial covering for the protection of textiles, uniforms, work wear, or protective clothing.

Articles produced according to the present teaching can vary widely in surface design using a matrix or embossing roll which can shape grain leather structures, textile structures, geometric structures, names, logos and surface areas of different structure and/or roughness. The only requirement here is the use of silicone rubber for the structuring surface of the matrix, or to shape the embossing roll accordingly, preferably lined with silicone rubber. The surfaces of the matrix or the embossing roll can be designed by reshaping, for example, a textile mechanically or by laser ablation.

The matrix used for structuring during production from layered material is not necessarily processed on the surface; instead, the matrix being used can be a negative matrix of an originally produced positive matrix.

The substrate layer is not visible through the polyurethane foam and thus it is possible to give different substrate layers a consistent appearance by means of uniform structuring of the surface of the layer of polyurethane foam.

The present teaching makes it possible to economize on polyurethane use, since the polyurethane dispersions are foamed and thus the amount of polyurethane required is reduced by the air bubbles contained in the polyurethane foam. This results at the same time in reduced weight for the polyurethane foam layer. Only water-based polyurethane dispersions are used, and thus production process is environmentally friendly and harmful or environmentally harmful process residues are avoided. Finally, rapid exchange of different matrices is possible, facilitating individualized production of articles. It is particularly advantageous if the substrate layer is used in the form of blanks coated with polyurethane foam. This eliminates the need to dispose of waste from the substrate layer, or the polyurethane foam is applied only to the blank and no residues of substrate layers containing polyurethane foam residues occur. It is particularly economical when small-format parts or stamped parts are separated and embossed from a large area of layered material coated with polyurethane foam.

### BRIEF DESCRIPTION OF THE DRAWINGS

The drawing shows schematically a section through a layered material constructed according to the present teaching. This layered material is created in such a way that a layer 2 made of a polyurethane foam is attached or applied to the surface of the substrate layer 1. If the substrate layer 1 is a textile material, then this textile material can be provided as base layer for precoating the surface with a layer 5 made of a soft PVC or made of a polyurethane foam from a polyurethane dispersion or polyurethane dispersion compound, in order to connect the layer 2 of polyurethane foam well with the possibly coarse textile material. With a substrate layer 1 which is formed by a textile material, such as woven or knitted fabric, the substrate layer 1 is provided with a layer 5 of polyurethane foam with a thickness of 0.20 to 0.35 mm or a layer 5 of a foamed soft PVC with a thickness of 0.250 to 0.450 mm. As a result, any impressing of the layer 2 into a coarse textile material is excluded. When embossing the layer 2 with the matrix 4 or an embossing roll 10, the layer 2 is reshaped, but does not penetrate into the substrate layer 1.

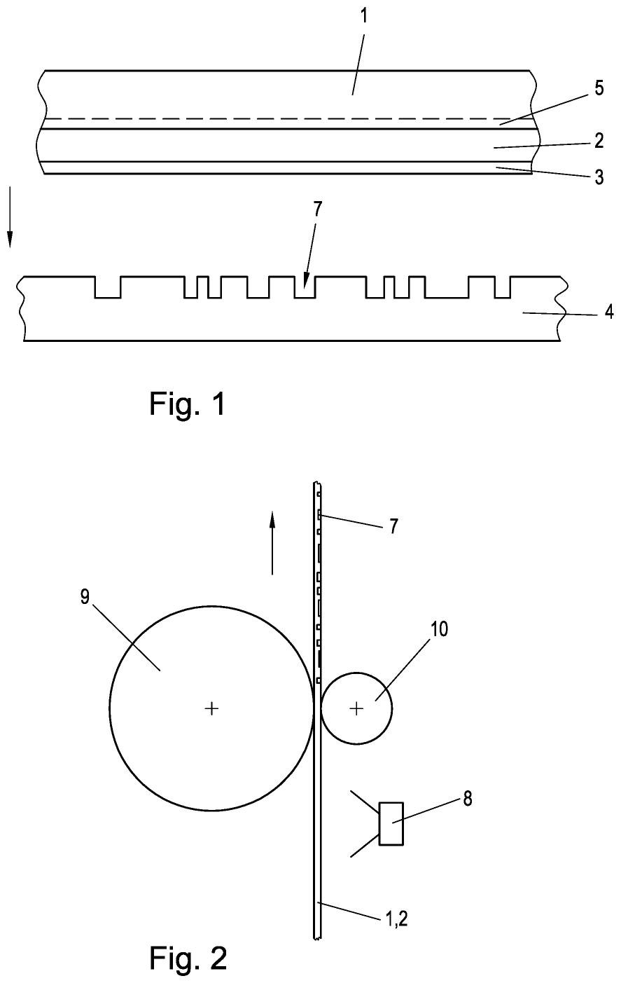

A layer 3 of a non-foamed polyurethane dispersion or polyurethane dispersion mixture can be applied to the layer 2 of polyurethane foam prior to its structuring. With a schematically illustrated matrix 4 or an embossing roll 10—as shown in FIG. 2—the layer 2 or the optionally present layer 3 can be given the indicated surface structure 7. With corresponding presses or pressure rollers 9 and heating devices 8 (infrared heaters), the substrate layer 1 and the matrix 4 are pressed against each other or pressed against the embossing roller 10. The matrix 4 is heated to the required temperature for the embossing process to bring the polyurethane foam to the desired softening temperature. If a cold embossing roller 10 is used, the layer 2 may be heated prior to its contact with the embossing roller 10 or matrix 4, for example with an infrared heater 8. When embossing with a steel roller 10, this roller is not heated, and thus any adhesion of the layer 2 or 3 is safely avoided. The layers 3 and 5 can also be formed with the same polyurethane dispersion compound or compounds as the polyurethane foam.

Use of a polyurethane foam as opposed to non-foamed coatings offers the advantage that when embossing under strong temperature and pressure, the surface-structured polyurethane foam is permeable to air and water vapor or remains and expands when heated. Air and moisture which, when applied to the layer 2, are present on the matrix 6, can escape, so that the embossing can proceed free of voids and bubbles.

When the polyurethane foam has dried, the sheet material can be punched into blanks prior to further processing, and the blanks are then subjected to embossing or surface structuring independently of one another, under strong pressure and temperature.

The layer 3 can either be applied directly to the polyurethane foam layer 2 or it is applied to the matrix 4 and dried on the matrix until anhydrous or almost anhydrous, and optionally pre-cross-linked so that it is removable there and, on embossing with the polyurethane foam layer 2, can be inseparably connected; this is no longer recognizable on the embossed layered material.

If a conventional unfoamed polyurethane dispersion layer is dried at a temperature of +120° C., a skin forms on its surface and the coating becomes brittle. However, when using a polyurethane foam, drying and embossing can start immediately at a temperature of about 120° C., and no cracks are formed in the pre-dried layer of polyurethane foam, because no skin forms to hinder the removal of water. In addition, unlike non-foam layers, the layer retains almost its original strength after drying.

The inventive procedure advantageously employs only non-toxic materials, which can also be processed economically and safely by unskilled workers. Furthermore, the embossing of an already dried polyurethane foam helps preserve the matrix, since the cross-linker contained in the polyurethane foam is not wet and does not come into contact with the matrix to the same extent as with conventional coatings because cross-linkers act aggressively and corrosively on silicone matrices.

When computing the specific gravity of the polyurethane foam, it should be remembered that depending on the application, it may contain pigments or additives of varying specific weight. For example, titanium dioxide is very difficult to use as a white coloring additive, whereas other colored pigments may have significantly lower specific gravity. If the open-pore polyurethane foam also contains hollow micro-spheres filled with gas, which are known to constitute open cells, these must be taken into account and deducted when calculating the density.

The foamed and thermoplastic layer 2 of polyurethane foam is compressed by means of heat and pressure to accept the negative structure of the matrix 4. The predominantly open-cell microfoam is thus compacted in such a way that some of the microcells are lost and the polyurethane foam still has an open-cell microfoam structure, which then only has a weight of 0.80 to 1.03 kg/dm³. On the other hand, a non-foamed compact layer produced with the same formulation has a density of 1.050 to 1.12 kg/dm³. These results, according to the present teaching, in an advantage in weight and material saved. By compressing the polyurethane foam, which can be controlled by embossing, in contrast to non-foamed coatings, deeper structures can be configured and, surprisingly, the softness is retained.

Because the layer 2 is permeable to water vapor and air, expanding gas or any residual water vapor arising during hot pressing is diverted through the layer 2 into the substrate layer 1 and no voids, bubbles and cracks are formed. When placing the dry layer 2 on the matrix that is hot or to be heated, it is important that the heat-expanding air or residual gases that cannot escape into or through the die, are able to be diverted through the open-cell polyurethane foam or through the substrate layer 1. If the layer did not have an open-celled microstructure, imperfections would result in the intervals between grains of the matrices, which would take the form of undesired pores and shiny patches.

Structured surfaces by means of heat pressing are mainly used for shoes, steering wheels, bags, leather goods, etc. According to the present teaching, format parts, for example in the dimensions between 0.35 and 0.9 m², can be produced easily by punching out sets of format parts with small chads or punch waste. A format part in this case can be large enough to cover the shaft parts, for example for a pair of shoes.

The complete polyurethane dispersion compound advantageously contains, before foaming, 0.90 to 4.2 wt. % of cross-linker, based on the total weight of the polyurethane dispersion compound. Advantageously, to improve the hydrolysis resistance, the respective polyurethane dispersion compound or compounds can contain from 8 to 25 wt. %. of a 40 to 50% acrylate dispersion, which is advantageously cross-linkable with isocyanate.

After drying and before the cross-linker takes effect, which at normal temperature begins after about 8 hours, the foamed layer may also be slightly tacky which makes stacking, at least at elevated temperatures, difficult (because of sticking together). To prevent this, optionally after drying and before stacking, the layer 2 can be covered with a polyethylene film or other thin material, such as release paper. Alternatively, according to the present teaching, in a simple and inexpensive manner, a thin layer (about 0.015 to 0.060 mm thick) of a harder polyurethane dispersion can be applied to the surface of the polyurethane foam of the layer 2 and cross-linked or dried; the said layer has a hardness of more than 70 shore A and is not foamed and optionally contains 1 to 4 wt. % of a polysiloxane.

If a 50% polyurethane dispersion, i.e., 50 parts solid and 50 parts water, is applied to a substrate as a film of, for example, 0.15 mm in thickness, this film shrinks or collapses by approximately 50% upon heat-drying, because of water loss. In addition, during drying (e.g. in the heat-drying channel) at +120° C., the film becomes brittle, because a skin forms on the surface, which makes water removal from the film under the skin difficult. The drying must therefore be done slowly and at low temperature, below 80° C. for a long period of time, which is uneconomical. According to the present teaching, however, a polyurethane foam is used, which does not collapse when drying by heat (e.g. in the drying channel), since no skin forms on the surface, because owing to the largely open microcells, the water or water vapor can continuously escape, even from lower areas, upward through the partially open microcells through the substrate layer. It should be noted that during hot pressing or structuring, the matrix advantageously lies at the bottom and the layered material with the layer 2 of polyurethane foam is placed on it, facing downward. Even with a layer thickness of 0.25 mm and at a drying temperature of 120° C., no cracks occur during drying. Furthermore, the drying time is shortened by more than 60% compared to a non-whipped dispersion layer without open-cell microstructure.

Furthermore, a compact polyurethane material is not readily embossable at low temperatures, since the material is compacted during embossing and must be able to flow. Here the easily reshapable foam, which is malleable after softening, offers considerable advantages.

In the context of the present teaching, in the case of a shallow grain, the polyurethane foam with its at least partially open-celled microstructure can be compacted at the surface on a hot matrix or silicone backing so that the surface is as homogeneous as possible at a thickness of 0.010 to 0.020 mm and as a result, it is more resistant to abrasion and more durable.

At the time of surface shaping, the layer 2 still behaves thermoplastically and becomes so elastic under pressure and heat impact that it also molds the finest microstructures in the surface of the matrix. Nevertheless, the substrate layer 1 with the structured layer 2 can be pulled off the matrix 4 immediately after embossing, that is, while layer 2 is still in the heated state. In the case of particularly difficult surfaces, such as structures in the nanoscale or velour surfaces, it is expedient to apply a non-foamed polyurethane dispersion having a solid content of 30 to 35 wt. % in an amount of 35 to 85 g/m² onto the matrix 4 and after drying to connect it with the layer 2.

The respective polyurethane dispersion compound or compounds contain foaming aids for foaming and for stabilizing the whipped foam, in the simplest case an ammonia-containing foaming agent in an amount from 0.5 to 2 wt. % (based on the total weight of the respective polyurethane dispersion). Thickening agents, e.g. Acronal-based (Wesopret A2), can be added to the respective polyurethane dispersion or the polyurethane dispersion mixture in an amount of 1 to 4 wt. % (based on the total weight of the respective polyurethane dispersion.

The polyurethane foam is formed by the stirring of gas or air by known agitators, similar to a stirrer for the production of whipped cream or egg whites.

The polyurethane dispersions used are aqueous polyurethane dispersions.

The measurement or verification of the softening point takes place on the Kofler bench.

According to the present teaching, particularly good reshaping properties for the configuration of the surface and an excellent connection between the substrate layer 1 and the foamed layer 2 are obtained if the polyurethane dispersion compound contains 18 to 52 wt. % of a polyurethane dispersion in the form of a heat-activated contact adhesive, which has a polyurethane solid content of 40 to 50% and is heat-activatable and, from a temperature of 4° C., becomes pasty and sticky. Such products are heat-activatable polyurethane-based dispersion contact adhesives, such as, for example, Luphen from BASF. After a cross-linker, such as the product Aquaderm XL 80 from Lanxess AG in Cologne, becomes effective, the polyurethane dispersion compound, which preferably contains the heat-activatable contact adhesive, loses its thermoplastic properties after the dried, anhydrous layer 2 of polyurethane foam, in shaping the surface, has been brought by means of heat and pressure to a temperature above 90° C., preferably above 110° C. Admixed to this polyurethane dispersion is a polyurethane dispersion in the amount of 39 to 73 wt. % based on the weight of the polyurethane dispersion compound whose softening point is higher than 125° C.

The present teaching also eliminates the known disadvantage that coatings produced with polyurethane dispersions on hydrophobic substrates only achieve insufficient adhesion or bonding. A hydrophobic substrate prevents penetration of polyurethane dispersion, which typically contains more than 40% water, into the surface of the substrate. This disadvantage of polyurethane dispersions for coating, known in the leather industry, is improved according to the present teaching, because the polyurethane foam used according to the present teaching, after drying during structuring, behaves like a heat-activatable adhesive, which penetrates under pressure into the finest depressions of the matrix and in the same way can penetrate the finest depressions of a substrate. The polyurethane foam anchors itself in the carrier like a hot melting adhesive and improves the adhesion.

### DETAILED DESCRIPTION

The present teaching will be explained in more detail below with reference to embodiments.

To determine whether a polyurethane dispersion compound or a polyurethane foam produced therewith is suitable for structuring, a test is made of the properties required for hot stamping, such as thermoplasticity, tackiness and flow behavior under heat and pressure. This is done by forming a layer with a thickness of 1.0 mm of a dried, not yet cross-linked polyurethane foam and evaluating it with respect to the aforementioned properties in the heating furnace or on the Kofler bench at a temperature between 90° C. and 145° C. In the event of a positive result, this layer of polyurethane foam is pressured in a press with a silicone rubber matrix having the desired surface structure, which has a shore A hardness of 75, at temperatures between 90° C. and 145° C. and press times between 2 and 18 s. At these temperatures, the polyurethane foam film has to be more or less sticky, but must not be liquid, must optimally match the template and must be easily removable from the matrix without deformation and without altering the formed structure. As a rule, the aforementioned commercially available polyurethane dispersions meet this requirement. By a corresponding mixing ratio of such commercial polyurethane dispersions, adjustments to different application purposes or different surface structures and different demands are possible and the softening and embossing temperature can be set or specified.

### Embodiment 1

The grain side of a steer's grain leather was abraded by 0.5 mm using 180-grit abrasive paper. On the abraded side, to form the layer 2, a polyurethane foam was applied at a thickness between 0.090 and 0.110 mm by means of a counter-rotating roller. At a temperature of 110° C. and with circulating air, the water content was reduced in the course of 2.5 minutes to 1.3 wt. %. The polyurethane foam decreased in thickness during drying only by 0.01 mm.

The foam was prepared from 420 g polyurethane dispersion with heat-activatable contact adhesive properties with a solid content of 40%, 480 g polyurethane dispersion with a high softening point of over +140° C. with a polyester-based amorphous structure and a solid content of 40%, 20 g Melio Foam paste, 30 g thickener, 50 g pigment.

The polyurethane dispersion mixture, after drying in the heating cabinet, had a softening point or range which allowed excellent embossing at a temperature of 125° C.

This mixture had a volume of 1.07 l and was whipped up or expanded with a commercial foam beater to a volume of 1.35 l by blowing in air. The foam with its whipped-cream consistency was applied to the abraded side of the grain leather at a thickness of 0.1 mm and dried. After 4 hours, the embossing was carried out, wherein the water content of the polyurethane foam was less than 1 wt. %.

The embossing was carried out with a matrix temperature of 128° C. and a pressure of 0.08 kg/m2. The pressure was maintained for 7 seconds.

The structure of the substrate or leather was not visible through the foam or the layer 2. The bonding or the layer formation was free of voids and bubbles; no collapse occurred. A thickness measurement showed that the polyurethane was about 8 to 10% thinner.

When a further layer 3 was formed on the polyurethane layer 2, which was prepared as indicated above, the water vapor permeability was 0.8 mg/cm2/h. In order to prepare this further layer 3, a layer of polyurethane dispersion mixture, which was not foamed, was applied in a thickness of 0.025 mm to the template 4 used for structuring and dried. Based on its total weight, this polyurethane dispersion mixture was prepared with 60 g polyurethane dispersion based on polycarbonate with a solid content of 32 wt. %. A dried layer of such a polyurethane dispersion has a shore A hardness of 75. To this was mixed 20 g of polyurethane dispersion based on polyester with a solid content of 35 wt. % and a shore A hardness in the dried state of 65. Moreover, this polyurethane dispersion mixture contained 4 g cross-linker, 5 g black pigment paste, 3 g polysiloxane and 1 g matting agent S100.

This polyurethane dispersion mixture with the specified additives was applied to the matrix 4 unfoamed 10 minutes before the structuring process. It was then dried to less than 1% water content. The connection of this further layer 3 with the polyurethane foam layer 2 that was on top of the carrier 1 as described above took place in the course of contacting the layer 2 with the matrix 4 at the embossing temperature and embossing pressure mentioned above. In this case, this further layer 3 was inseparably connected to the polyurethane foam layer 2.

The resulting high adhesion of polyurethane dispersion-based layers in hydrophobic substrates, in particular in hydrophobized leathers in combination with the improved water vapor permeability, is a prerequisite, above all, for safety shoes of the class S2 and S3 and is readily met with the inventive layered material.

It has also been found that when using a foamed soft PVC precoated substrate it is preferable to prepare the polyurethane foam layer only with polyurethane dispersions based on polyester or polycarbonate. In the case of PU dispersions based on polyethers, a plasticizer migration could possibly occur in the polyurethane foam.

Commercially available polyurethane dispersions are used as polyurethane dispersions for producing the polyurethane foam for layers 2 and 5. These commercial polyurethane dispersions are based on aliphatic polyester or polyether or polycarbonate polyurethanes. Such polyurethane dispersions have a solid content of 35 to 52. The pH of such PU dispersions is between 6.5 and 8.5. After water removal or drying, the film which forms has an elongation at break of between 280 and 650%. These polyurethane dispersions can be cross-linked with XL80. The hardness of a dried and cross-linked unfoamed film of such polyurethane dispersions has a shore A hardness between 35 and 95, preferably 45 to 85. The layers formed are odor-neutral and free of impermissible chemicals.

Commercially available silicone-rubber impression materials are used for the preparation of the matrixes 4, and the matrices have a shore A hardness between 40 and 85. The density of the matrices is more than 1,150 g/cm3 and are cross-linked by condensation or additive. The created matrices can be engraved by laser or mechanically.

### Embodiment 2

A polyurethane dispersion compound was prepared with:

460 g of commercially available polyurethane contact adhesive dispersion with heat-activatable contact adhesive properties and with a solid content of 40 wt. %,
510 g of commercial polyurethane dispersion based on aliphatic polyether with a solid content of 40% and a softening point of a dried layer (0.5 wt. % water) of 155° C.,
6 g black pigment paste,
4 g compressor in the form of polyacrylate,
2 g MELIO foam paste,
3 g cross-linker,
10 g polyacrylate dispersion having a solid content of 50 wt. %,
5 g hollow microspheres with a diameter of 20 μ.

This resulted in a polyurethane dispersion compound with a weight of 1000 g, which occupies a volume of 1.04 l. One liter of such a polyurethane dispersion was whipped to 1.34 l. The whipped polyurethane dispersion mixture has a high viscosity and is virtually thixotropic.

A layer of 0.13 mm was applied with a counter-rotating applicator roll on a microfiber nonwoven and dried within 3 minutes in a circulating air dryer at a temperature of 115° C. to 1.0 wt. % water content. After 3 hours, shoe upper parts were punched out and pressed and structured at a temperature of 120° C. and a pressure of 0.05 kg/cm2 for 5 seconds with a surface-structured silicone matrix.

The stamped parts show in the positive the precise structure of the negative matrix, which had the appearance of kangaroo leather. The layer 2 had a thickness of 0.065 mm and the adhesion between the substrate and the layer 2 was 28 N/cm.

### Embodiment 3

A polyurethane foam was applied to a kangaroo leather with sanded grain according to Embodiment 2 by means of a roller at a thickness of 0.09 mm and dried at a temperature of 95° C. to 1 wt. % water. Subsequently, shoe upper blanks for soccer shoes were punched out and structured as shown in Embodiment 2. The thickness of the layer 2 was 0.07 mm and the adhesion between the substrate 1 and the layer 2 was 16.5 N/cm.

### Embodiment 4

A mixture of polyurethane dispersions, but white in color, containing 12 g of titanium oxide, according to Embodiment 2, was foamed and the polyurethane foam was applied to form the layer 2 airlessly at a thickness of 0.12 mm on a microfiber nonwoven and at a temperature dried from 120° C. for 3 minutes to less than 1 wt. % water. Next, shoe upper parts were punched out. A 0.040 mm thick non-foamed polyurethane dispersion was applied to a die with a negative suede structuring. The solid content of this dispersion was 30 wt. %. Furthermore, this dispersion contained 5 wt. % of red pigment paste. The thickness of this layer after drying to 0.5 wt. % water content was 0.018 mm. The stamped parts were placed on the layer 3 on the die 4 and, as in Embodiment 2 described above, pressed, wherein the layers 2 and 3 were inseparably connected to each other.

### Embodiment 5

A substrate made of textile material was coated with a soft PVC foam and another substrate made of textile material was coated with polyurethane foam as a sheet precoated with a thickness of 0.30 mm according to Embodiment 2 to form a layer 2. On each of these precoated substrates, a heat-structurable layer 2 of polyurethane foam was applied with a doctor blade in a thickness between 0.15 mm and dried to a water content of less than 1 wt. %. On this layer 2, an unfoamed layer 3 of a polyurethane dispersion was applied in a thickness of 0.035 mm. This PU dispersion had a solid content of 30 wt. % and a cross-linker as content in the amount of 5 wt. %. After drying the layer 3, the blank or the layers 2 and 3 were structured at a temperature of 145° C. and firmly connected together with the layer 5.

The present teaching is particularly advantageous for the production of formatted and cut parts, such as for safety shoes or steering wheels. This results in a good full-surface connection between the respective substrate material 1 and the layer 2. At the same time it leads to a temperature resistance up to at least +125° C. It serves to meet the requirement that up to these temperatures, storage for 24 hours can take place, whereby the structure of the surface, its color and the degree of gloss or any expected mattness may not change. Extreme requirements apply in the molding of matrices which have a surface structure obtained by molding a fabric of textile fibers or in the molding of surfaces of carbon fiber fabrics. The structure formed on the layer 2 corresponds exactly to the matrix structure in its three-dimensionality as well as its degree of gloss and mattness. An exact three-dimensional image is obtained particularly well if, on the matrix 4 before the application of the layer 2, a thin polyurethane dispersion of the thickness of 0.025 to 0.06 mm of a cross-linked polyurethane dispersion with a softening point higher than +125° C. is applied. This dispersion contains aliphatic polyester and has a hardness after cross-linking that is greater than 75 shore A. Such a polyurethane dispersion has a solid content of 25 to 32% by weight and as an addition 3% cross-linker, 6% by weight of pigments, 3% by weight of polysiloxane, 0.5 wt. % of matting agent. On the dried polyurethane layer 2, this layer 3 is applied in the manner already described.

For layered material in the form of sheet material, in particular with a textile substrate made of woven or knitted fabric, a precoating is carried out with a layer 5 of foamed soft PVC or a cross-linkable polyurethane foam. It is advantageous here to apply the foam layer 2 to the layer 5 by means of a doctor blade. After drying, this layer is applied to this layer 3, preferably with a pressure roller. The drying of the applied polyurethane layers 2 and 3 takes place on the web-shaped carrier 1 with the layer 5 in the continuous dryer. The structuring is carried out in such a way that the layer 3 and the layer 2 of polyurethane foam are brought to a temperature between 145 and 165° C. by means of infrared radiators and are embossed under pressure by means of a structured roller. This results in the advantage that the more heat-resistant layer 3 prevents sticking of the polyurethane foam layer 2 on a non-heated patterning roller.

The embossing speed depends on the type of structuring, in particular on the grain depth, and ranges from 5 to 55 s/m of the layered material.

In the case of a substrate 1 precoated with soft PVC, it is advantageous to choose the temperature and/or the embossing speed and/or the pressure such that the PVC layer is at least slightly patterned, whereby this layer 5, like the polyurethane foam layer 2, decreases in thickness.

It has proved advantageous for the structuring of the polyurethane foam layer 2 if, during structuring, a pressurization of at least 6 g/cm2, preferably of at least 12 g/cm2, takes place. Furthermore, the polyurethane foam for structuring should not be thin but pasty and readily malleable under pressure in order to be able to image the fine structures of the matrix; regardless of whether it is sheet-like layered material or layered material in the form of format parts or blanks.

The polyurethane foam of the layer 2 is at its most advantageous consistency when the polyurethane foam has a similar flowing viscosity as soft PVC at a temperature between 160 and 180° C., so that it is flowable and shapable under pressure. This also applies if, prior to the structuring of the layer 2, an additional layer 3 is applied to this layer 2.

The formation of a corresponding degree of softening or a desired shapable consistency can also be controlled by the amount of cross-linker used and/or by the mixing ratio of polyurethane dispersions having a low or higher softening point or softening range.

Matting agents, in particular the matting agent TS100 from Evonik Degussa GmbH used for layers 2 and 3, improve the texture, result in a dry touch and improve water vapor permeability.

The drying of the layer 2 occurs under heat in the dryer or continuous dryer. A layer of polyurethane foam in accordance with the inventive density range, below tenths of millimeters, takes 2 to 6 minutes at 80 to 120° C., depending on the composition of the dispersion, to be dried until free of water. A wet foam at a thickness of 0.5 mm, dried in a heating or convection oven with circulating air and at a temperature of +120° C., proved to be absolutely anhydrous and dry in 4.5 minutes. At the same temperature for a period of 1.5 to 2.5 minutes, the polyurethane foam layer contains less than 1.5 wt. % water.

It is advantageous to dry as completely as possible, preferably to freedom from water. The required temperature and time are empirically easy to determine. Since the water content of polyurethane dispersions or of the polyurethane foam is precisely known, it is also possible, for instance by weighing, to determine how much water has already evaporated during drying. In addition, freedom from water can be recognized if no disturbing vapor emerges during the structuring process.

It is also possible to determine the water content in the dried polyurethane dispersion or polyurethane dispersion compound when exposed to heat, by measuring the residual water content after different time intervals. It is thus easy to obtain a desired residual water content or to set the required temperature and delay time for it. Absence of water can also be obtained in this way, or the required parameters can be set for the process. Advantageously, water is completely or almost completely removed.

With certain applications, for example shoes, to avoid adverse effects to color pigments from polyurethane dispersions, the layer 2 can be reduced in the course of structuring, under pressure and heat, to a certain thickness. For this purpose, with the same polyurethane dispersion used for the polyurethane foam layer 2, an amount of equivalent weight is applied to the same area as foreseen for the foam, and the thickness of this comparative layer is determined. In structuring, the layer 2 is compressed to a thickness 2 to 18%, preferably 3 to 9%, greater than that of the comparative layer.

The reduction of the thickness of the layer 2 is mainly appropriate for sanded grain leather and substrate 1 made of microfiber nonwovens, used to make formatting or stamping parts for shoes whose surface is to be structured. The layer 2 is compacted, and thus the load capacity, abrasion resistance and the bending capacity of the layer 2 are improved. In addition, this serves to counteract the lightening of the foam or of the layer 2, which occurs during the foaming up of the polyurethane foam because of the increase in volume while the amount of dyes or pigments remains constant, and also color intensity and color homogeneity are ensured.

The shaping of the surface by means of heat and pressure and a negative matrix or negative embossing or roller, can also be carried out in a vacuum process, that is, by means of a low-pressure treatment. For example, porous embossing rollers or porous matrixes may be used, or the space between the pressure plates is emptied. Such pressing methods using vacuum or low pressure are known in the art.

In structuring the polyurethane foam or the layer 2, it is possible, according to the present teaching, to apply reinforcing and/or molded parts to the matrix 4 and/or the layer 2. In the pressuring process with the application of pressure and at elevated temperature, these parts are firmly bound to the layer 2 and, if present, to the layer 3. These reinforcements or molded parts can be designed as desired and can assume the shape of stripes, circles, stars, geometric or other figures, and so on. The most appropriate materials include plastic or all materials usable for the substrate 1, especially in the form of films or thin molded or stamped parts.

Particularly advantageous values for the layer 2 are obtained when the polyurethane foam is applied to the substrate 1 at a thickness of 0.070 to 0.250 mm.

1. A method for producing a layered material, which has a substrate layer and a layer of polyurethane bonded to the substrate layer, wherein the substrate layer is bonded to the layer, so that at least one layer of foamed polyurethane foam is applied to the substrate as the layer,
wherein the liquid polyurethane foam is produced with a polyurethane dispersion compound, so that the individual polyurethane dispersions used to produce the polyurethane dispersion compound display different softening points in the dried state,
to produce a polyurethane dispersion compound, a polyurethane dispersion with heat-activatable contact adhesion properties or with a softening point in dry condition of at least 40° C. with a mass of 18 to 52 wt. % of the finished polyurethane compound and a polyurethane dispersion without contact adhesion properties or with a softening point higher than 95° C. with a mass of 38 to 73. wt. % of the finished polyurethane dispersion compound, are mixed together,
the layer is applied on the substrate layer at a thickness of 0.030 to 0.60 mm,
before or simultaneously with a structuring of the polyurethane foam by a matrix of silicone rubber, an additional layer made of a non-foamed polyurethane foam is applied to the layer, and
small-format parts or stamped parts are separated from a large-surface layered material coated with polyurethane foam and are imprinted, or
after the polyurethane foam has dried, before further processing the layered material is stamped to fragments and the fragments, independently of one another, are then subjected to stamping or surface structuring under pressure and temperature.

2. The method according to claim 1, wherein:
the layer, after it is applied to the substrate layer, is dried to a water content of less than 1.5 wt. % to the point where it is free of water, and/or
to produce the polyurethane foam, an aqueous polyurethane dispersion compound based on aliphatic polyether and/or polyester and/or polycarbonate polyurethane is used, and/or
the polyurethane dispersions are selected so that the polyurethane dispersion compound possesses thermoplastic properties after it is dried and before it is cross-linked,
the polyurethane foam dispersion compound used to produce the polyurethane foam contains 65 to 91 wt. % polyurethane dispersions—based on the weight of the polyurethane dispersion compound—so that the polyurethane dispersions used to produce the polyurethane foam contain in each case 35 to 52 wt. % solid material based on the weight of the respective polyurethane dispersion, and/or
the polyurethane of the polyurethane dispersions being used has at least partially linear and/or at least partial crystalline and/or thermoplastic or amorphous structure.

3. The method according to claim 1, wherein the polyurethane foam is produced by applying a gas or gas bubbles to the polyurethane dispersions or polyurethane dispersion compound, so that in one liter of the polyurethane dispersion or polyurethane dispersion compound, as much gas is introduced or applied so that 1 liter assumes a volume of 1.10 to 1.70 liters.

4. The method according to claim 1, wherein to produce a polyurethane dispersion compound, a polyurethane dispersion with heat-activatable contact adhesion properties or with a softening point in dry condition of at least 40° C. with a mass of 18 to 52 wt. % of the finished polyurethane compound and a polyurethane dispersion without contact adhesion properties or with a softening point higher than 95° C. with a mass of 39 to 73 wt. % of the finished polyurethane dispersion compound, are mixed together.

5. The method according to claim 1, wherein
the polyurethane foam is sprayed onto the substrate layer or applied using the silk-screening method or with at least one roller or a squeegee, at uniform thickness, and/or
in using a microfiber nonwoven as the substrate layer, the intervals between the fibers of the nonwoven are filled at least partially with coagulated or foamed synthetic foam.

6. The method according to claim 1, wherein, before structuring the surface of the layer of polyurethane foam onto the structure-shaping matrix, the additional layer is configured from a non-foamed polyurethane dispersion at a strength of 0.015 to 0.060 mm, containing at most 1.5 wt. % water, contains no adhesion properties, at least to a temperature of 110° C., and is solidified and/or cross-linked Jo the point where it can be withdrawn from the structured matrix without residual adhesiveness, and this layer that is situated on the matrix warmed to a temperature of 90 to 145° C. is brought in contact with the layer and is pressurized and connected with this layer in the course of the structuring, so that advantageously this layer, after structuring, has a shore A hardness of 55 to 95 and, in some cases, a different color than the layer.

7. The method according to claim 1, wherein the additional layer is applied on the layer in that, before the structuring of the layer with a matrix, the additional layer made of a polyurethane dispersion with, in some cases, a different, preferably greater, hardness and/or color is directly applied to the layer or connected to it, so that the additional layer is formed of a non-foamed polyurethane dispersion and is applied at a strength of 0.015 to 0.060 mm, and, in some cases, is dried to a water content of at most 1.5 wt. % water.

8. The method according to claim 1, wherein
to produce a surface-structured layering material, the dried layer, in some cases simultaneously or jointly with the additional layer, is pressurized and in some cases reduced in thickness with a structured matrix which has a temperature of 110 to 155° C., so that for a heated matrix a contact duration of 2 to 18 s and a contract pressure of 0.04 to 1.8 kg/cm2 are maintained, or the layer, in some cases simultaneously or together with the layer, is brought to a temperature of 110 to 155° C., for example with IR radiation, and is pressurized and structured and in some cases reduced in thickness with a matrix that is cold or at most warmed to 75° C., and/or
that the thickness of the layer of sprayed polyurethane foam in the course of applying the surface structure or embossing at the pre-established temperature and the pre-established pressure is reduced and thereby the thickness of the layer is such that it remains thicker by 2 to 18% than a comparable layer which is produced from an equally great amount of non-foamed polyurethane dispersion or non-foamed polyurethane dispersion compound of the same composition and is distributed over the same surface as the polyurethane foam, and/or
the embossing is conducted by a surface-structured matrix of silicone rubber mass with a shore A hardness of 40 to 85.

9. The method according to claim 1, wherein
additives are applied to the polyurethane dispersion or polyurethane dispersion compound, and/or
the polyurethane foam is subjected to warming and pressurizing means in such a way that, after structuring with the matrix, the layer has a thickness of 0.80 to 1.030 kg/cm3, and/or
cross-linkers with a mass of 0.9 to 4.2 wt. % based on total weight of the polyurethane foam are applied to the polyurethane dispersion or the polyurethane dispersion compounds, and after structuring and cross-linking under pressure and temperature, lose their adhesiveness and are thermoplastic, and/or
8 to 25 wt. %. based on the total weight of the polyurethane foam, undergo a 40 to 60% acrylate dispersion, and/or
to produce the polyurethane foam, polyurethane dispersions or polyurethane dispersion compounds are employed in which, after a drying process, a dry layer of the polyurethane foam thereby produced, with a surface of 1 m2 and a thickness of 1.00 mm, weighs 0.78 to 1.03 kg before its structuring.

10. The method according to claim 1, wherein before applying the layer of polyurethane foam to a substrate layer composed of a textile material, such as a woven or knitted fabric, a thin layer is applied to the surface of the textile material, said layer consisting of possibly foamed soft PVC or of a foamed or non-foamed cross-linkable polyurethane dispersion or a non-foamed cross-linkable polyurethane dispersion compound with a polyurethane solid content of 20 to 35 wt. %, and constitutes a connecting layer for the layer of polyurethane foam that is to be applied.

11. A layered material comprising a substrate layer and a layer connected therewith made of polyurethane, wherein the substrate layer is produced according to the method of claim 1, wherein the layer is composed of at least one layer of a polyurethane foam that is not cross-linked or not yet cross-linked or weakly cross-linked and which, in some cases, has a maximum water content of 1.5 wt. %, so that the layer has a softening point above 90° C. and is sticky at a temperature of 90 to 145° C., has thermoplastic properties and is viscous under pressure and/or can be permanently reshaped and, after structuring and cross-linking carried out under pressure and temperature change, loses its stickiness and is thermoplastic, so that an additional layer of a non-foamy polyurethane dispersion is applied to the layer.

12. The layered material according to claim 11, wherein
the polyurethane of the layer has a specific weight of 0.8 to 1.03 kg/dm3 and/or
the layer of polyurethane foam has a thickness of 0.030 to 0.40 mm, and/or
the polyurethanes used for the layer are aliphatic polyurethanes on a polyether or polyester or polycarbonate base and/or
the layer of polyurethane foam contains pigments and/or cross-linkers and/or polyacrylates and/or hollow microspheres and/or matting means, and/or
the layer of reinforced, dried polyurethane foam has a shore A hardness of 28 to 68.

13. The layered material according to claim 11, wherein, in a substrate layer made of a textile material, between the textile material and the layer a thin layer is configured, which consists of foamed soft PVC or of a cross-linked foam layer of a polyurethane dispersion and the said layer has a thickness of 0.25 to 0.45 mm and constitutes a connecting layer for the layer of polyurethane foam that is to be applied, so that, in some cases, the two layers include a total thickness of 0.3 to 0.5 mm.

14. The layered material according to claim 11, wherein on the layer a thin, heat-structurable, non-foamed layer consisting of a polyurethane dispersion or polyurethane dispersion compound with a thickness of 0.0150 to 0.60 mm, is mounted on or connected to the layer, so that a structure corresponding to the structural embossing in the layer is configured or impressed in the layer of polyurethane foam and so that the layer advantageously includes a greater shore A hardness than the layer or a hardness of more than 70 shore A and, in some cases, contains 1 to 4 wt. % polysiloxane.

15. The layered material according to claim 11, wherein
the grain leather is a full-grain steer's leather of which the grain layer has been removed by at least 5% to at most 60% by mechanical means, and/or
the fibers of the microfiber nonwoven consist of polyester or polyamide, so that the hollow spaces between fibers are impregnated or filled with a synthetic material, including a foam structure or a coagulated microcellular structure, and/or
the polyurethane foam has an open-cellular structure and/or is permeable to air and/or includes a water vapor permeability of more than 0.50 mg/cm²/h according to DIN EN ISO 14268.

16. Objects produced by using a layered material according to claim 11, such as broadloom, cuttings, stamped parts, shoe parts, sport and work shoes, inlaid shoe soles, pouches, leather goods, steering wheel covers, cushion coverings, inner wall coverings and seat covers for power vehicles, wherein the surface of the objects or the layer includes a structural embossing.

17. The objects according to claim 16, wherein the layer and in some cases also the layer connected with the layer or mounted on the layer is shaped or structured thermoplastically or by using heat and pressure.

18. The objects according to claim 16, wherein
a structuring is configured or imprinted on the surface of the layer, and/or
the layer of polyurethane foam has a thickness that is only 2 to 18% thicker as a layer that is made of a weight-equalized quantity consisting of a non-foamed polyurethane dispersion or non-foamed polyurethane dispersion compound of the same composition, after this quantity has been distributed in the shape of a layer over an equal-sized surface such as the polyurethane foam.

19. The objects according to claim 16, wherein the polyurethane foam of the layer is not cross-linked or is almost completely cross-linked.
